(19) United States
(12) Patent Application Publication
(10) Pub. No.: US 2016/0066328 A1
(43) Pub. Date: Mar. 3, 2016

(54) SCHEDULING METHOD, USER EQUIPMENT, AND BASE STATION

(71) Applicant: HUAWEI TECHNOLOGIES CO., LTD., Shenzhen (CN)

(72) Inventors: Zhenxing HU, Shenzhen (CN); Wei QUAN, Beijing (CN); Jian ZHANG, Beijing (CN)

(73) Assignee: HUAWEI TECHNOLOGIES CO., LTD., Shenzhen (CN)

(21) Appl. No.: 14/935,940

(22) Filed: Nov. 9, 2015

Related U.S. Application Data
(63) Continuation of application No. PCT/CN2013/075504, filed on May 10, 2013.

(51) Int. Cl. H04W 72/04; H04W 72/12

(52) U.S. Cl. CPC H04W 72/0453; H04W 72/1242; H04W 72/1205

(57) ABSTRACT

Embodiments of the present invention provide a scheduling method, user equipment (UE), and a base station, and relate to the field of communications technologies. The method includes: triggering, by UE, a schedule request (SR); and sending the SR to a base station according to configuration statuses of uplink resources of multiple carriers or carrier groups of the UE. By using the technical solutions of the present invention, uplink resources are configured on multiple carriers or carrier groups of UE, so that when an SR is triggered, at least one carrier can be selected according to specific configuration statuses of the uplink resources to send the SR; therefore, a problem that a delay in sending the SR is caused due to existing limitations of the uplink resources is avoided, and the SR can be flexibly sent.

### CROSS-REFERENCE TO RELATED APPLICATIONS

This application is a continuation of International Application No. PCT/CN2013/075504, filed on May 10, 2013, which is hereby incorporated by reference in its entirety.

### TECHNICAL FIELD

The present invention relates to the field of communications technologies, and in particular, to a scheduling method, user equipment, and a base station.

### BACKGROUND

With the development of mobile communications technologies and broadband wireless access technologies, to meet requirements of broadbandization of mobile communication and cope with challenges from mobility of broadband communication, a CA (carrier aggregation) technology is introduced into the 3GPP (The 3rd Generation Partnership Project); in CA, multiple carriers of different frequency bands are aggregated to form larger transmission bandwidth, so that UE (user equipment) simultaneously receives and sends data on the multiple carriers. By using the CA technology, larger bandwidth can be obtained, and a peak data rate and a system throughput can be increased.

In an uplink of an LTE (Long Term Evolution) system, when UE needs to perform uplink transmission and does not have sufficient uplink resources, the UE sends an SR (schedule request) on a PUCCH (physical uplink control channel) to a base station; after detecting the SR, the base station allocates an uplink scheduling resource to the UE; and the UE sends a BSR (buffer status report) to the base station according to the allocated uplink scheduling resource, to report a buffer data status of the UE.

In inter-base station carrier aggregation, the SR can be carried only in a PUCCH resource on a primary carrier of multiple carriers and is then sent, thereby causing a delay in sending the SR if the primary carrier has no available PUCCH resource when the SR is triggered, and affecting a normal service of the UE.

### SUMMARY

To resolve a problem of a delay in sending an SR, embodiments of the present invention provide a scheduling method, user equipment, and a base station. The technical solutions are as follows:

According to a first aspect, a scheduling method is provided, where the method includes:

triggering, by user equipment (UE), a schedule request (SR); and

sending the SR to a base station according to configuration statuses of uplink resources of multiple carriers or carrier groups of the UE.

With reference to the first aspect, in a first possible implementation manner of the first aspect, the sending the SR to a base station according to configuration statuses of uplink resources of multiple carriers or carrier groups of the UE includes:

when a specified uplink resource is configured on any carrier or carrier group in the multiple carriers or carrier groups, adding the SR to the specified uplink resource and sending the SR to the base station, where the specified uplink resource is an uplink resource used for sending the SR; or

when specified uplink resources are configured on at least two carriers or carrier groups in the multiple carriers or carrier groups, adding, according to priorities of the at least two carriers or carrier groups, the SR to a specified uplink resource of a carrier or carrier group with a highest priority, and sending the SR to the base station; or

when a specified uplink resource is configured on a carrier triggering the SR or a carrier group to which a carrier triggering the SR belongs in the multiple carriers or carrier groups, adding the SR to the specified uplink resource and sending the SR to the base station; or

when a specified uplink resource is configured on a first carrier or carrier group in the multiple carriers or carrier groups, adding the SR to the specified uplink resource and sending the SR to the base station, where the first carrier or carrier group is a carrier or carrier group corresponding to a radio bearer to which an evolved packet system (EPS) bearer corresponding to a logical channel group corresponding to a BSR triggering the SR is mapped.

With reference to the first possible implementation manner of the first aspect, in a second possible implementation manner of the first aspect,

the priorities of the at least two carriers or carrier groups are determined according to priorities, which are configured by the base station, of the carriers or carrier groups; or

the priorities of the at least two carriers or carrier groups are determined according to load of the at least two carriers or carrier groups; or

the priorities of the at least two carriers or carrier groups are determined according to ratios of data rates provided by the at least two carriers or carrier groups to the UE to an ideal data rate of each carrier in each carrier or carrier group in the at least two carriers or carrier groups.

With reference to either one of the implementation manners of the first aspect, in a third possible implementation manner of the first aspect, after the sending the SR to a base station according to configuration statuses of uplink resources of multiple carriers or carrier groups of the UE, the method further includes:

receiving an uplink grant that is sent by the base station according to the SR; and

adding a buffer status report (BSR) to any carrier or carrier group in the multiple carriers or carrier groups of the UE according to the uplink grant and sending the BSR to the base station; or

adding a buffer status report (BSR) to a carrier or carrier group triggering the BSR in the multiple carriers or carrier groups of the UE according to the uplink grant, and sending the BSR to the base station; or

adding a buffer status report (BSR) to a first carrier or first carrier group in the multiple carriers or carrier groups of the UE according to the uplink grant and sending the BSR to the base station, where the first carrier or first carrier group is the carrier or carrier group corresponding to the radio bearer to which the evolved packet system (EPS) bearer corresponding to the logical channel group corresponding to the BSR triggering the SR is mapped.

With reference to any one of the implementation manners of the first aspect, in a fourth possible implementation manner of the first aspect, after the sending the SR to a base station according to configuration statuses of uplink resources of multiple carriers or carrier groups of the UE, the method includes:

when a quantity of times of sending the SR exceeds a preset quantity of times and no uplink grant returned by the base station is received, sending the SR on a carrier or carrier group in the multiple carriers or carrier groups except the carrier or carrier group triggering the SR; or

when no uplink grant is received within a first preset time length after the SR is triggered, sending the SR on a carrier or carrier group in the multiple carriers or carrier groups except the carrier or carrier group triggering the SR; or

when a current data rate of any radio bearer of the UE is less than a first data rate, sending the SR on a carrier or carrier group in the multiple carriers or carrier groups except the carrier or carrier group triggering the SR; or

when a current data rate of any radio bearer of the UE is less than a first data rate and keeps in a state of being less than the first data rate for a time longer than a second preset time length, sending the SR on a carrier or carrier group in the multiple carriers or carrier groups except the carrier or carrier group triggering the SR; or

when a current data rate of the UE is less than a second data rate, sending the SR on a carrier or carrier group in the multiple carriers or carrier groups except the carrier or carrier group triggering the SR; or

when a current data rate of the UE is less than a second data rate and keeps in a state of being less than the second data rate for a time longer than a third preset time length, sending the SR on a carrier or carrier group in the multiple carriers or carrier groups except the carrier or carrier group triggering the SR.

With reference to any one of the implementation manners of the first aspect, in a fifth possible implementation manner of the first aspect, the sending the SR to a base station according to configuration statuses of uplink resources of multiple carriers or carrier groups of the UE includes:

when an SR prohibition timer of the UE is not run, sending the SR to the base station according to the configuration statuses of the uplink resources of the multiple carriers or carrier groups of the UE;

or

when an SR prohibition timer of the carrier or carrier group triggering the SR is not run, sending the SR to the base station according to the configuration statuses of the uplink resources of the multiple carriers or carrier groups of the UE.

With reference to any one of the implementation manners of the first aspect, in a sixth possible implementation manner of the first aspect, before the sending the SR to a base station according to configuration statuses of uplink resources of multiple carriers or carrier groups of the UE, the method further includes:

acquiring, by the UE, an SR sending manner configured by using a Radio Resource Control (RRC) message or a Media Access Control control element (MAC CE).

According to a second aspect, a scheduling method is further provided, where the method includes:

receiving, by a base station, an SR sent by user equipment; and

sending, by the base station, an uplink grant on any carrier or carrier group of the base station to the user equipment according to the received SR; or

sending, by the base station according to the received SR, an uplink grant on a carrier or carrier group, corresponding to a carrier or carrier group receiving the SR, of the base station to the user equipment.

According to a third aspect, a scheduling method is further provided, where the method includes:

receiving, by a base station, a BSR sent by user equipment; and

sending, by the base station, an uplink grant on any carrier or carrier group of the base station to the user equipment according to the received BSR; or

sending, by the base station according to the received BSR, an uplink grant on a carrier or carrier group, corresponding to a carrier or carrier group receiving the BSR, of the base station to the user equipment; or

sending, by the base station according to the received BSR, an uplink grant on a carrier or carrier group associated with the BSR to the user equipment.

According to a fourth aspect, user equipment (UE) is provided, including:

a triggering module, configured to trigger a schedule request (SR); and

a sending module, configured to send the SR to a base station according to configuration statuses of uplink resources of multiple carriers or carrier groups of the UE.

With reference to the fourth aspect, in a first possible implementation manner of the fourth aspect, the sending module includes:

a first SR sending unit, configured to: when a specified uplink resource is configured on any carrier or carrier group in the multiple carriers or carrier groups, add the SR to the specified uplink resource and send the SR to the base station, where the specified uplink resource is an uplink resource used for sending the SR; or

a second SR sending unit, configured to: when specified uplink resources are configured on at least two carriers or carrier groups in the multiple carriers or carrier groups, add, according to priorities of the at least two carriers or carrier groups, the SR to a specified uplink resource of a carrier or carrier group with a highest priority, and send the SR to the base station; or

a third SR sending unit, configured to: when a specified uplink resource is configured on a carrier triggering the SR or a carrier group to which a carrier triggering the SR belongs in the multiple carriers or carrier groups, add the SR to the specified uplink resource and send the SR to the base station; or

a fourth SR sending unit, configured to: when a specified uplink resource is configured on a first carrier or carrier group in the multiple carriers or carrier groups, add the SR to the specified uplink resource and send the SR to the base station, where the first carrier or carrier group is a carrier or carrier group corresponding to a radio bearer to which an evolved packet system (EPS) bearer corresponding to a logical channel group corresponding to a BSR triggering the SR is mapped.

With reference to the first possible implementation manner of the fourth aspect, in a second possible implementation manner of the fourth aspect, the priorities of the at least two carriers or carrier groups are determined according to priorities, which are configured by the base station, of the carriers or carrier groups; or

the priorities of the at least two carriers or carrier groups are determined according to load of the at least two carriers or carrier groups; or

the priorities of the at least two carriers or carrier groups are determined according to ratios of data rates provided by the at least two carriers or carrier groups to the UE to an ideal data rate of each carrier in each carrier or carrier group in the at least two carriers or carrier groups.

With reference to either one of the implementation manners of the fourth aspect, in a third possible implementation manner of the fourth aspect, the user equipment further includes:

an uplink grant receiving module, configured to receive an uplink grant that is sent by the base station according to the SR; and

the sending module further includes:

a first BSR sending unit, configured to add a buffer status report (BSR) to any carrier or carrier group in the multiple carriers or carrier groups of the UE according to the uplink grant and send the BSR to the base station; or

a second BSR sending unit, configured to add a buffer status report (BSR) to a carrier or carrier group triggering the BSR in the multiple carriers or carrier groups of the UE according to the uplink grant, and send the BSR to the base station; or

a third BSR sending unit, configured to add a buffer status report (BSR) to a first carrier or first carrier group in the multiple carriers or carrier groups of the UE according to the uplink grant and send the BSR to the base station, where the first carrier or first carrier group is the carrier or carrier group corresponding to the radio bearer to which the evolved packet system (EPS) bearer corresponding to the logical channel group corresponding to the BSR triggering the SR is mapped.

With reference to any one of the implementation manners of the fourth aspect, in a fourth possible implementation manner of the fourth aspect, the sending module further includes:

a preset-quantity-of-times sending unit, configured to: when a quantity of times of sending the SR exceeds a preset quantity of times and no uplink grant returned by the base station is received, send the SR on a carrier or carrier group in the multiple carriers or carrier groups except the carrier or carrier group triggering the SR; or

a preset-time-length sending unit, configured to: when no uplink grant is received within a first preset time length after the SR is triggered, send the SR on a carrier or carrier group in the multiple carriers or carrier groups except the carrier or carrier group triggering the SR; or

a first-rate sending unit, configured to: when a current data rate of any radio bearer of the UE is less than a first data rate, send the SR on a carrier or carrier group in the multiple carriers or carrier groups except the carrier or carrier group triggering the SR; or

a first-rate and time-length sending unit, configured to: when a current data rate of any radio bearer of the UE is less than a first data rate and keeps in a state of being less than the first data rate for a time longer than a second preset time length, send the SR on a carrier or carrier group in the multiple carriers or carrier groups except the carrier or carrier group triggering the SR; or

a second-rate sending unit, configured to: when a current data rate of the UE is less than a second data rate, send the SR on a carrier or carrier group in the multiple carriers or carrier groups except the carrier or carrier group triggering the SR; or

a second-rate and time-length sending unit, configured to: when a current data rate of the UE is less than a second data rate and keeps in a state of being less than the second data rate for a time longer than a third preset time length, send the SR on a carrier or carrier group in the multiple carriers or carrier groups except the carrier or carrier group triggering the SR.

With reference to any one of the implementation manners of the fourth aspect, in a fifth possible implementation manner of the fourth aspect, the sending module further includes:

a first prohibition timer unit, configured to: when an SR prohibition timer of the UE is not run, send the SR to the base station according to the configuration statuses of the uplink resources of the multiple carriers or carrier groups of the UE; or

a second prohibition timer unit, configured to: when an SR prohibition timer of the carrier or carrier group triggering the SR is not run, send the SR to the base station according to the configuration statuses of the uplink resources of the multiple carriers or carrier groups of the UE.

With reference to any one of the implementation manners of the fourth aspect, in a sixth possible implementation manner of the fourth aspect, the user equipment further includes:

a receiving module, configured to acquire, by the UE, an SR sending manner configured by using a Radio Resource Control (RRC) message or a Media Access Control control element (MAC CE).

According to a fifth aspect, a base station is further provided, including:

a receiving module, configured to receive an SR sent by user equipment; and

a sending module, configured to send an uplink grant on any carrier or carrier group to the user equipment according to the received SR; or configured to send, according to the received SR, an uplink grant on a carrier or carrier group corresponding to a carrier or carrier group receiving the SR to the user equipment.

According to a sixth aspect, a base station is further provided, where the base station includes:

a receiving module, configured to receive a BSR sent by user equipment; and

a sending module, configured to send an uplink grant on any carrier or carrier group to the user equipment according to the received BSR; or configured to send, according to the received BSR, an uplink grant on a carrier or carrier group corresponding to a carrier or carrier group receiving the BSR to the user equipment; or configured to send, according to the received BSR, an uplink grant on a carrier or carrier group associated with the BSR to the user equipment.

According to a seventh aspect, user equipment is further provided, including: a receiver, a transmitter, a memory, and a processor, where the receiver, the transmitter, and the memory are separately connected to the processor, the memory stores program code, and the processor is configured to invoke the program code, to execute the following operations:

triggering a schedule request (SR); and

sending the SR to a base station according to configuration statuses of uplink resources of multiple carriers or carrier groups of the user equipment by using the transmitter.

According to an eighth aspect, a base station is further provided, including: a receiver, a transmitter, a memory, and a processor, where the receiver, the transmitter, and the memory are separately connected to the processor, the memory stores program code, and the processor is configured to invoke the program code, to execute the following operations:

receiving, by using the receiver, an SR sent by user equipment; and

sending an uplink grant on any carrier or carrier group of the base station to the user equipment according to the received SR by using the transmitter; or

sending, according to the received SR, an uplink grant on a carrier or carrier group, corresponding to a carrier or carrier group receiving the SR, of the base station to the user equipment.

According to a ninth aspect, a base station is further provided, including: a receiver, a transmitter, a memory, and a processor, where the receiver, the transmitter, and the memory are separately connected to the processor, the memory stores program code, and the processor is configured to invoke the program code, to execute the following operations:

receiving, by using the receiver, a BSR sent by user equipment; and

sending an uplink grant on any carrier or carrier group of the base station to the user equipment according to the received BSR by using the transmitter; or

sending, by the processor according to the received BSR, an uplink grant on a carrier or carrier group, corresponding to a carrier or carrier group receiving the BSR, of the base station to the user equipment by using the transmitter; or

sending, by the processor according to the received BSR, an uplink grant on a carrier or carrier group associated with the BSR to the user equipment by using the transmitter.

When user equipment (UE) has a schedule request (SR) in a pending state, the SR is sent to a base station according to configuration statuses of uplink resources of multiple carriers or carrier groups of the UE, so that after receiving the SR, the base station allocates an uplink grant to the UE, and the UE sends a buffer status report (BSR) by using the uplink grant. By using the technical solutions of the present invention, uplink resources are configured on multiple carriers or carrier groups of UE, so that when an SR is triggered, at least one carrier can be selected according to specific configuration statuses of the uplink resources to send the SR; therefore, a problem that a delay in sending the SR is caused due to existing limitations of the uplink resources is avoided, and the SR can be flexibly sent according to the specific configuration statuses of the uplink resources of the carriers or carrier groups.

### BRIEF DESCRIPTION OF DRAWINGS

To describe the technical solutions in the embodiments of the present invention more clearly, the following briefly introduces the accompanying drawings required for describing the embodiments. Apparently, the accompanying drawings in the following description show merely some embodiments of the present invention, and a person of ordinary skill in the art may still derive other drawings from these accompanying drawings without creative efforts.

FIG. 1 is a flowchart of a scheduling method according to an embodiment of the present invention;

FIG. 2 is a flowchart of a scheduling method according to an embodiment of the present invention;

FIG. 3 is a flowchart of a scheduling method according to an embodiment of the present invention;

FIG. 4 is a flowchart of a scheduling method according to an embodiment of the present invention;

FIG. 5 is a flowchart of a scheduling method according to an embodiment of the present invention;

FIG. 6 is a flowchart of a scheduling method according to an embodiment of the present invention;

FIG. 7 is a flowchart of a scheduling method according to an embodiment of the present invention;

FIG. 8 is a schematic structural diagram of user equipment (UE) according to an embodiment of the present invention;

FIG. 9 is a schematic structural diagram of a base station according to an embodiment of the present invention;

FIG. 10 is a schematic structural diagram of a base station according to an embodiment of the present invention;

FIG. 11 is a schematic structural diagram of user equipment according to an embodiment of the present invention;

FIG. 12 is a schematic structural diagram of a base station according to an embodiment of the present invention;

FIG. 13 is a schematic structural diagram of a base station according to an embodiment of the present invention;

FIG. 14 is a schematic structural diagram of a MAC of user equipment according to an embodiment of the present invention;

FIG. 15 is a schematic structural diagram of another MAC of user equipment according to an embodiment of the present invention; and

FIG. 16 is a schematic structural diagram of another MAC of user equipment according to an embodiment of the present invention.

### DESCRIPTION OF EMBODIMENTS

To make the objectives, technical solutions, and advantages of the present invention clearer, the following further describes the embodiments of the present invention in detail with reference to the accompanying drawings.

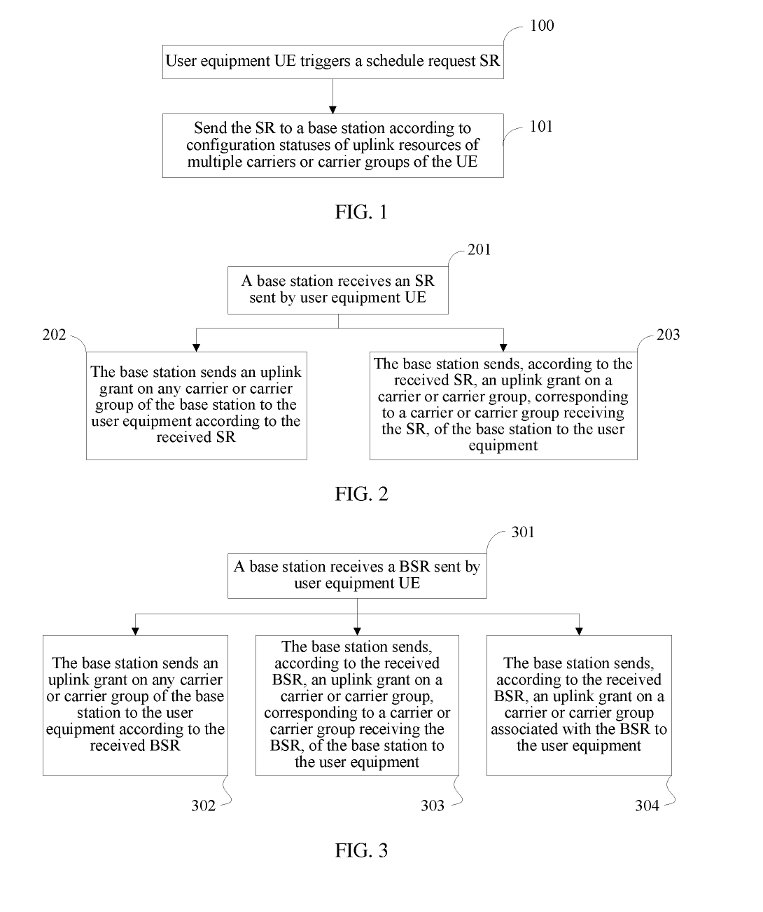

FIG. 1 is a flowchart of a scheduling method according to an embodiment of the present invention. The method in this embodiment of the present invention is executed by user equipment. Referring to FIG. 1, the method includes:

100: User equipment (UE) triggers a schedule request (SR).

In this embodiment of the present invention, when the UE needs to send uplink data to a base station, the UE needs to first send a BSR to the base station, so as to report a buffer data status of the UE, to acquire a resource of the base station to transmit the uplink data in a buffer of the UE; and when the UE needs to send the BSR to the base station but no uplink grant of the base station is received yet, a trigger condition is met, and the SR is triggered, to apply to the base station for an uplink scheduling resource and an uplink grant, so as to send the BSR to the base station.

When the UE has triggered the SR and the SR is not sent yet, it may be considered that the SR is in a pending state.

101: Send the SR to a base station according to configuration statuses of uplink resources of multiple carriers or carrier groups of the UE.

In this embodiment of the present invention, the UE has multiple carriers or carrier groups, which are used for uplink communication with the base station, where uplink resources may be configured on all of the multiple carriers or carrier groups, and when the SR is in a pending state, the SR may be sent by using an uplink resource configured on at least one carrier or carrier group in the multiple carriers.

Specifically, when the UE has an SR in a pending state and uplink resources are configured on multiple carriers or carrier groups of the UE, the SR is sent to a base station by using an uplink resource, and after receiving the SR, the base station allocates an uplink grant to the UE, so that the UE sends a buffer status report (BSR) by using the uplink grant.

In the method provided in this embodiment of the present invention, when user equipment (UE) has a schedule request (SR) in a pending state, the SR is sent to a base station according to configuration statuses of uplink resources of multiple carriers or carrier groups of the UE, so that after receiving the SR, the base station allocates an uplink grant to the UE, and the UE sends a buffer status report (BSR) by using the uplink grant. By using the technical solution of the present invention, uplink resources are configured on multiple carriers or carrier groups of UE, so that when an SR is triggered, at least one carrier can be selected according to specific configuration statuses of the uplink resources to send the SR; therefore, a problem that a delay in sending the SR is caused due to existing limitations of uplink resources is avoided, and the SR can be flexibly sent according to the specific configuration statuses of the uplink resources of the carriers or carrier groups.

Optionally, on a basis of the technical solution of the embodiment shown in FIG. 1, in step 101 “Send the SR to a base station according to configuration statuses of uplink resources of multiple carriers or carrier groups of the UE”, any manner in the following steps 101a, 101b, 101c, and 101d may be used:

101a: When a specified uplink resource is configured on any carrier or carrier group in the multiple carriers or carrier groups, add the SR to the specified uplink resource and send the SR to the base station, where the specified uplink resource is an uplink resource used for sending the SR.

In this embodiment of the present invention, the uplink resource used for sending the SR may be configured on any carrier in the multiple carriers or carrier groups of the UE, and when the SR is in a pending state, a carrier or carrier group on which a specified uplink resource is configured in the multiple carriers or carrier groups is determined by detecting the multiple carriers or carrier groups or according to carrier configuration that is learned by the UE in advance.

Specifically, when the SR is in a pending state, and a specified uplink resource is configured on any carrier or carrier group in the multiple carriers or carrier groups, that is, the SR may be sent by using the specified uplink resource on the any carrier or carrier group, the SR is carried in the specified uplink resource and sent to the base station. In this embodiment of the present invention, selection on the any carrier or carrier group is not limited.

By using the technical solution of the present invention, an SR in a pending state can be sent by using any carrier or carrier group on which a specified uplink resource is configured in multiple carriers or carrier groups; therefore, a problem of a delay in sending the SR is resolved, and the SR can be flexibly sent according to specific configuration statuses of uplink resources of the carriers or carrier groups.

101b: When specified uplink resources are configured on at least two carriers or carrier groups in the multiple carriers or carrier groups, add, according to priorities of the at least two carriers or carrier groups, the SR to a specified uplink resource of a carrier or carrier group with a highest priority, and send the SR to the base station.

A difference between step 101b and step 101a lies in that, specified uplink resources are configured on at least two carriers or carrier groups in the multiple carriers or carrier groups, and the at least two carriers or carrier groups have priorities.

Specifically, when the SR is in a pending state and specified uplink resources are configured on at least two carriers in the multiple carriers or carrier groups, according to priorities of the at least two carriers, the SR is sent by using a specified uplink resource of a carrier with a highest priority, that is, the SR is carried in the specified uplink resource of the carrier with the highest priority and is sent to the base station.

Alternatively, when the SR is in a pending state and specified uplink resources are configured on at least two carrier groups in the multiple carriers or carrier groups, according to priorities of the at least two carrier groups, the SR is sent by using a specified uplink resource of a carrier group with a highest priority, that is, the SR is carried in the specified uplink resource of the carrier group with the highest priority and is sent to the base station.

By using the technical solution of the present invention, a carrier used for sending an SR can be determined according to priorities of multiple carriers or carrier groups, so that an SR in a pending state is sent on a carrier or carrier group which has a highest priority and on which a specified uplink resource is configured; therefore, a problem of a delay in sending the SR is resolved, and the SR can be flexibly sent according to specific configuration statuses of uplink resources of the carriers.

101c: When a specified uplink resource is configured on a carrier triggering the SR or a carrier group to which a carrier triggering the SR belongs in the multiple carriers or carrier groups, add the SR to the specified uplink resource and send the SR to the base station.

Multiple carriers may be divided into multiple carrier groups according to different base stations corresponding to the multiple carriers and different frequency bands in which the multiple carriers are located, that is, any carrier group may be carriers of a same base station, or carriers within a same frequency band. When a specified uplink resource is configured on any carrier in the carrier group, it may be considered that the specified uplink resource is configured on the carrier group.

Specifically, when the SR is in a pending state and a specified uplink resource is configured on a carrier triggering the SR in the multiple carriers or carrier groups, the SR is carried in the specified uplink resource and sent to the base station.

Alternatively, when the SR is in a pending state and a specified uplink resource is configured on any carrier of a carrier group to which a carrier triggering the SR belongs in the multiple carriers or carrier groups, the SR is carried in the specified uplink resource and sent to the base station.

For example, a carrier triggering the SR is a carrier a, a carrier group to which the carrier a belongs is a carrier group X, and then when a specified uplink resource is configured on the carrier a, the SR may be carried in the specified uplink resource and sent to the base station; or when a specified uplink resource is configured on a carrier b in the carrier group X, the SR may be carried in the specified uplink resource and sent to the base station, where the carrier a and the carrier b are different carriers.

In inter-base station carrier aggregation, an SR and a BSR can only be carried in a PUCCH resource on a primary carrier and sent, if the to-be-sent SR or BSR corresponds to a secondary carrier, the SR or BSR needs to be transferred to the secondary carrier, and a delay exists in a backhaul between the base stations, resulting in a delay in transmission of a data packet. By using the technical solution of the present invention, a carrier or carrier group used for sending an SR can be determined according to a carrier or carrier group triggering the SR, so that the SR in a pending state is sent on a carrier or carrier group on which a specified uplink resource is configured, and the SR does not need to be transferred between carriers; therefore, a problem of a delay in sending the SR is resolved, and the SR can be flexibly sent according to specific configuration statuses of uplink resources of carriers.

101d: When a specified uplink resource is configured on a first carrier or carrier group in the multiple carriers or carrier groups, add the SR to the specified uplink resource and send the SR to the base station, where the first carrier or carrier group is a carrier or carrier group corresponding to a radio bearer to which an evolved packet system (EPS) bearer, corresponding to a logical channel group that corresponds to a BSR triggering the SR, is mapped.

In this embodiment of the present invention, the SR is sent to the base station so as to obtain an uplink scheduling resource, and a BSR is sent to the base station according to the uplink scheduling resource; therefore, the SR corresponds to the BSR, and it may be considered that the BSR triggers the SR.

A person skilled in the art may learn that, the BSR is sent to the base station according to a resource of a logical channel group, and an EPS bearer corresponding to the logical channel group is mapped to a radio bearer.

When the SR is in a pending state and a specified uplink resource is configured on the carrier or carrier group corresponding to the radio bearer to which the evolved packet system (EPS) bearer, corresponding to the logical channel group that corresponds to the BSR triggering the SR, is mapped, that is, the first carrier or first carrier group, the SR in a pending state is carried in the specified uplink resource and sent to the base station.

In addition, it should be noted that, when a specified uplink resource is configured on only one carrier or carrier group in the multiple carriers or carrier groups, the SR is carried on the carrier or carrier group on which the specified uplink resource is configured, and is then sent, and when specified uplink resources are configured on two or more carriers or carrier groups in the multiple carriers or carrier groups, any carrier or carrier group on which a specified uplink resource is configured may be selected to carry the SR, or the SR may be simultaneously carried on the two or more carriers or carrier groups on which the specified uplink resources are configured, and then is sent.

By using the technical solution of the present invention, uplink resources are configured on multiple carriers or carrier groups of UE, so that when an SR is triggered, at least one carrier can be selected according to specific configuration statuses of the uplink resources to send the SR; therefore, a problem that a delay in sending the SR is caused due to existing limitations of the uplink resources is avoided, and the SR can be flexibly sent according to the specific configuration statuses of the uplink resources of the carriers or carrier groups.

Optionally, on a basis of the technical solution of the embodiment shown in FIG. 1, in step 101b “When specified uplink resources are configured on at least two carriers or carrier groups in the multiple carriers or carrier groups, add, according to priorities of the at least two carriers or carrier groups, the SR to a specified uplink resource of a carrier or carrier group with a highest priority, and send the SR to the base station”, a priority of a carrier in the multiple carriers may be determined in any manner in the following steps 101b-1, 101b-2, and 101b-3:

101b-1: The priorities of the at least two carriers or carrier groups are determined according to a primary/secondary relationship of the at least two carriers or carrier groups.

Specifically, a priority of a primary carrier in the at least two carriers or carrier groups is higher than another carrier that is a secondary carrier, and a priority of a primary carrier group is higher than another carrier group.

101b-2: The priorities of the at least two carriers or carrier groups are determined according to load of the at least two carriers or carrier groups.

Specifically, the priorities of the at least two carriers are determined according to load of the at least two carriers, where higher load of a carrier in the at least two carriers indicates that a priority of the carrier is lower; or the priorities of the at least two carrier groups are determined according to load of the at least two carrier groups, where higher load of a carrier group in the at least two carrier groups indicates that a priority of the carrier group is lower.

101b-3: The priorities of the at least two carriers or carrier groups are determined according to ratios of data rates provided by the at least two carriers or carrier groups to the UE to an ideal data rate of each carrier in each carrier or carrier group in the at least two carriers or carrier groups.

An ideal data rate of each carrier in the at least two carriers or carrier groups refers to a data rate that should be provided by each carrier in the at least two carriers or carrier groups to the UE according to network configuration, and an ideal rate of each carrier in the at least two carrier groups refers to a data rate that should be provided by each carrier in the at least two carrier groups to the UE according to network configuration. The data rate may include a prioritized bit rate, a guaranteed bit rate, a maximum bit rate, an average rate, or the like.

An average rate is used as an example. An average rate provided by any carrier in the at least two carriers or carrier groups to the UE is V1, an ideal average rate of the any carrier is V2, and a priority of the any carrier is determined according to a ratio of V1 to V2, where a greater ratio indicates that the priority of the any carrier priority is lower; an average rate provided by the at least two carrier groups to the UE is V3, an ideal average data rate of each carrier in the at least two carrier groups is V4, and priorities of the at least two carrier groups are determined according to a ratio of V3 to V4, where a greater ratio indicates that the priorities of the at least two carrier groups are lower.

Optionally, on a basis of the technical solution of the embodiment shown in FIG. 1, after step 101 “Send the SR to a base station according to configuration statuses of uplink resources of multiple carriers or carrier groups of the UE”, in the method, step 102 and any manner in 103a to 103c in the following may be further used:

102: Receive an uplink grant that is sent by the base station according to the SR.

In this case, the uplink grant sent for the SR is used for instructing the user equipment to send the BSR on the uplink grant.

103a: Add a buffer status report (BSR) to any carrier in the multiple carriers of the UE according to the uplink grant, and send the BSR to the base station, so that the base station acquires a buffer data status of the UE.

Specifically, when the uplink grant is received, it indicates that the UE has obtained the uplink grant of the base station, and can send the BSR to the base station; in this case, the BSR is carried in an uplink scheduling resource, which is configured by the base station, according to the uplink grant and sent to the base station, that is, the BSR is carried on any carrier or carrier group in the multiple carriers of the UE and sent to the base station, so that the base station acquires the buffer data status of the UE.

103b: Add a buffer status report (BSR) to a carrier or carrier group triggering the BSR in the multiple carriers of the UE according to the uplink grant, and send the BSR to the base station, so that the base station acquires a buffer data status of the UE.

Specifically, when the uplink grant is received and the uplink grant indicates that the base station configures an uplink scheduling resource for the UE on a carrier triggering the BSR in the multiple carriers or carrier groups of the UE, the BSR is carried on the carrier triggering the BSR in the multiple carriers of the UE and is sent to the base station, so that the base station acquires the buffer data status of the UE; or when the uplink grant is received and the uplink grant indicates that the base station configures an uplink scheduling resource for the UE on a carrier group triggering the BSR in the multiple carriers or carrier groups of the UE, the BSR is carried on the carrier group triggering the BSR in the multiple carriers or carrier groups of the UE and is sent to the base station, so that the base station acquires the buffer data status of the UE.

103c: Add a buffer status report (BSR) to a first carrier or first carrier group in the multiple carriers or carrier groups of the UE according to the uplink grant and send the BSR to the base station, so that the base station acquires a buffer data status of the UE, where the first carrier or first carrier group is the carrier or carrier group corresponding to the radio bearer to which the evolved packet system (EPS) bearer, corresponding to the logical channel group that corresponds to the BSR triggering the SR, is mapped.

Specifically, when the uplink grant is received and the uplink grant indicates that the base station configures an uplink scheduling resource for the UE on the first carrier, the BSR is carried on the first carrier in the multiple carriers of the UE and sent to the base station, so that the base station acquires the buffer data status of the UE; or when the uplink grant is received and the uplink grant indicates that the base station configures an uplink scheduling resource for the UE on the first carrier group, the BSR is carried on first carrier group in the multiple carriers or carrier groups of the UE and sent to the base station, so that the base station acquires the buffer data status of the UE.

Optionally, on a basis of the technical solution of the embodiment shown in FIG. 1, after step 101 “Send the SR to a base station according to configuration statuses of uplink resources of multiple carriers or carrier groups of the UE”, in the method, any manner in the following steps 104a to 104f may be further used:

104a: When a quantity of times of sending the SR exceeds a preset quantity of times and no uplink grant returned by the base station is received, send the SR on a carrier or carrier group in the multiple carriers except the carrier triggering the SR.

In this embodiment of the present invention, when the UE has sent the SR and receives no uplink grant returned by the base station, the SR may be sent again, and when a quantity of times of sending the SR exceeds a preset quantity of times and still no uplink grant returned by the base station is received, the SR is sent on a carrier or carrier group in the multiple carriers or carrier groups except the carrier or carrier group triggering the SR, so as to quickly receive an uplink grant allocated by the base station.

The preset quantity of times may be preset by technical personnel, which is not limited in this embodiment of the present invention.

104b: When no uplink grant is received within a first preset time length after the SR is triggered, send the SR on a carrier or carrier group in the multiple carriers or carrier groups except the carrier or carrier group triggering the SR.

In this embodiment of the present invention, after the UE triggers the SR, a counter for a quantity of times of transmitting the SR (SR_COUNTER) of the UE is initialized to a preset initial value, and after the UE sends the SR, a value of the SR_COUNTER increases by a preset counting interval; preferably, the preset initial value is 0, and the preset counting interval is 1.

Specifically, after the UE triggers the SR, a time in which the value of the SR_COUNTER keeps being the preset initial value is calculated, and when the time of keeping exceeds the first preset time length and no uplink grant is received, the SR is sent on the carrier or carrier group in the multiple carriers or carrier groups except the carrier or carrier group triggering the SR.

The first preset time length may be preset by technical personnel during development, which is not limited in this embodiment of the present invention.

104c: When a current data rate of any radio bearer of the UE is less than a first data rate, send the SR on a carrier or carrier group in the multiple carriers or carrier groups except the carrier or carrier group triggering the SR.

The first data rate may be preset by technical personnel during development, which is not limited in this embodiment of the present invention.

104d: When a current data rate of any radio bearer of the UE is less than a first data rate and keeps in a state of being less than the first data rate for a time longer than a second preset time length, send the SR on a carrier or carrier group in the multiple carriers or carrier groups except the carrier or carrier group triggering the SR.

Specifically, when a current data rate of any radio bearer of the UE is less than the first data rate, a time in which the current data rate keeps less than the first data rate is counted, and when the time of keeping exceeds the second preset time length, the SR is sent on the carrier or carrier group in the multiple carriers or carrier groups except the carrier or carrier group triggering the SR.

The second preset time length may be preset by technical personnel during development, which is not limited in this embodiment of the present invention.

104e: When a current data rate of the UE is less than a second data rate, send the SR on a carrier or carrier group in the multiple carriers or carrier groups except the carrier or carrier group triggering the SR.

The second data rate may be preset by technical personnel during development, which is not limited in this embodiment of the present invention.

104f: When a current data rate of the UE is less than a second data rate and keeps in a state of being less than the second data rate for a time longer than a third preset time length, send the SR on a carrier or carrier group in the multiple carriers or carrier groups except the carrier or carrier group triggering the SR.

Specifically, when a current data rate of the UE is less than the second data rate, a time in which the current data rate keeps less than the second data rate is counted, and when the time of keeping exceeds the third preset time length, the SR is sent on the carrier or carrier group in the multiple carriers or carrier groups except the carrier or carrier group triggering the SR.

The third preset time length may be preset by technical personnel during development, which is not limited in this embodiment of the present invention.

Optionally, on a basis of the technical solution of the embodiment shown in FIG. 1, step 101 “Send the SR to a base station according to configuration statuses of uplink resources of multiple carriers or carrier groups of the UE” includes 101e or 101f:

101e: When an SR prohibition timer of the UE is not run, send the SR to the base station according to the configuration statuses of the uplink resources of the multiple carriers or carrier groups of the UE.

Specifically, when the SR is in a pending state, it is detected whether the SR prohibition timer of the UE is run, and when the SR prohibition timer of the UE is not run, the SR is sent to the base station according to the configuration statuses of the uplink resources of the multiple carriers or carrier groups of the UE.

101f: When an SR prohibition timer of the carrier or carrier group triggering the SR is not run, send the SR to the base station according to the configuration statuses of the uplink resources of the multiple carriers or carrier groups of the UE.

Specifically, when the SR is in a pending state, it is detected whether the SR prohibition timer of the carrier or carrier group triggering SR is run, and when the SR prohibition timer of the carrier or carrier group triggering SR is not run, the SR is sent to the base station according to the configuration statuses of the uplink resources of the multiple carriers or carrier groups of the UE.

Optionally, on a basis of the technical solution of the embodiment shown in FIG. 1, before step 101 “Send the SR to a base station according to configuration statuses of uplink resources of multiple carriers or carrier groups of the UE”, the method further includes: acquiring, by the UE, an SR sending manner configured by using an RRC (Radio Resource Control) message or a MAC (Media Access Control) CE (control element).

Specifically, the SR sending manner is carried by a base station network side on an RRC message, and the UE acquires the RRC message; or the SR sending manner is configured by a base station network side according to the MAC CE, and the UE acquires the SR sending manner. This embodiment of the present invention sets no limitation thereto.

FIG. 2 is a flowchart of a scheduling method according to an embodiment of the present invention. The method in this embodiment of the present invention is executed by a base station. Referring to FIG. 2, the method includes:

201: A base station receives an SR sent by user equipment (UE), and performs step 202 or step 203.

202: The base station sends an uplink grant on any carrier or carrier group of the base station to the user equipment according to the received SR.

The uplink grant is used for instructing the user equipment to send a BSR on the uplink grant to the base station.

203: The base station sends, according to the received SR, an uplink grant on a carrier or carrier group, corresponding to a carrier or carrier group receiving the SR, of the base station to the user equipment.

Specifically, the base station sends, to the user equipment, the uplink grant on a carrier corresponding to a carrier receiving the SR, or the base station sends, to the user equipment, the uplink grant on a carrier group corresponding to a carrier group to which a carrier receiving the SR belongs.

In the method provided in this embodiment of the present invention, when user equipment (UE) has a schedule request (SR) in a pending state, the SR is sent to a base station according to configuration statuses of uplink resources of multiple carriers or carrier groups of the UE, so that after receiving the SR, the base station allocates an uplink grant to the UE, and the UE sends a buffer status report (BSR) by using the uplink grant. By using the technical solution of the present invention, uplink resources are configured on multiple carriers or carrier groups of UE, so that when an SR is triggered, at least one carrier can be selected according to specific configuration statuses of the uplink resources to send the SR; therefore, a problem that a delay in sending the SR is caused due to existing limitations of the uplink resources is avoided, and the SR can be flexibly sent according to the specific configuration statuses of the uplink resources of the carriers or carrier groups.

FIG. 3 is a flowchart of a scheduling method according to an embodiment of the present invention. The method in this embodiment of the present invention is executed by a base station. Referring to FIG. 3, the method includes:

301: A base station receives a BSR sent by user equipment (UE), and performs step 302, step 303, or step 304.

302: The base station sends an uplink grant on any carrier or carrier group of the base station to the user equipment according to the received BSR.

In this case, the uplink grant is used for instructing the user equipment to send data in a buffer of the user equipment to the base station.

303: The base station sends, according to the received BSR, an uplink grant on a carrier or carrier group, corresponding to a carrier or carrier group receiving the BSR, of the base station to the user equipment.

Specifically, the base station sends, to the user equipment, the uplink grant on a carrier corresponding to a carrier receiving the BSR, or the base station sends, to the user equipment, the uplink grant on a carrier group corresponding to a carrier group to which a carrier receiving the BSR belongs.

In this embodiment of the present invention, the corresponding carrier refers to a carrier, receiving the BSR, of the base station, and an associated carrier refers to a carrier triggering the BSR.

304: The base station sends, according to the received BSR, an uplink grant on a carrier or carrier group associated with the BSR to the user equipment.

The carrier or carrier group associated with the BSR refers to a carrier or carrier group corresponding to a radio bearer to which an EPS bearer, corresponding to a logical channel group that corresponds to the BSR, is mapped.

In the method provided in this embodiment of the present invention, when user equipment (UE) has a schedule request (SR) in a pending state, the SR is sent to a base station according to configuration statuses of uplink resources of multiple carriers or carrier groups of the UE, so that after receiving the SR, the base station allocates an uplink grant to the UE, and the UE sends a buffer status report (BSR) by using the uplink grant. By using the technical solution of the present invention, uplink resources are configured on multiple carriers or carrier groups of UE, so that when an SR is triggered, at least one carrier can be selected according to specific configuration statuses of the uplink resources to send the SR; therefore, a problem that a delay in sending the SR is caused due to existing limitations of the uplink resources is avoided, and the SR can be flexibly sent according to the specific configuration statuses of the uplink resources of the carriers or carrier groups.

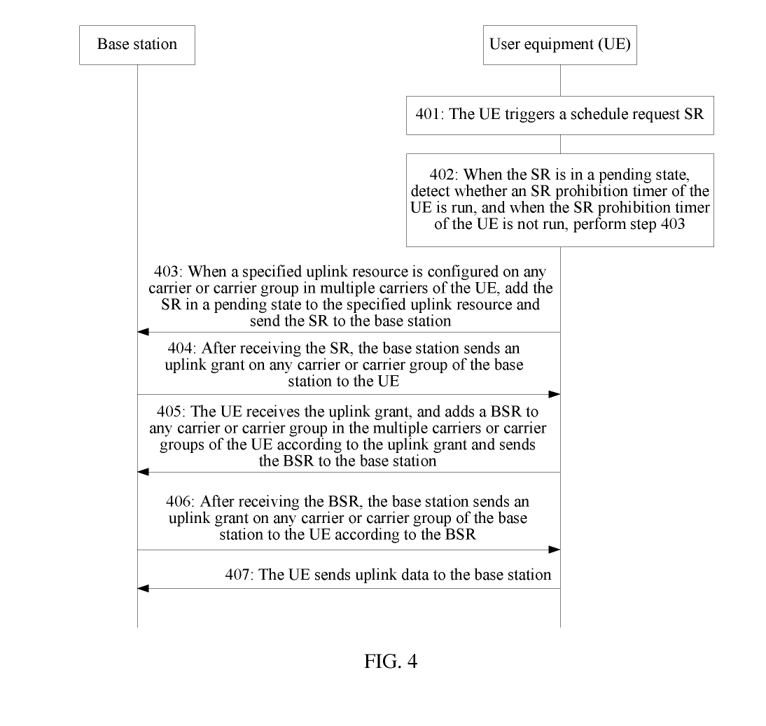

FIG. 4 is a flowchart of a scheduling method according to an embodiment of the present invention. In this embodiment of the present invention, two parties of interaction are user equipment and a base station, and description is made by using an example in which when an SR of the UE is in a pending state and a specified uplink resource is configured on any carrier or carrier group in multiple carriers or carrier groups, the SR in a pending state is carried in the specified uplink resource and sent to the base station. Referring to FIG. 4, the method includes:

401: UE triggers a schedule request (SR).

Optionally, before step 401, the method further includes step 400:

400: A base station configures an SR sending manner by using an RRC message.

The base station configures an SR sending manner, that is a configuration status of a specified uplink resource, for the UE by using an RRC message, and sends the SR sending manner to the UE. When acquiring the RRC message, the UE can learn the configuration status of the specified uplink resource, so as to send an SR according to the specified uplink resource in a subsequent process.

402: When the SR is in a pending state, detect whether an SR prohibition timer of the UE is run, and when the SR prohibition timer of the UE is not run, perform step 403.

403: When a specified uplink resource is configured on any carrier or carrier group in multiple carriers of the UE, add the SR in a pending state to the specified uplink resource and send the SR to the base station.

Preferably, the specified uplink resource is a PUCCH resource.

Before an uplink grant sent by the base station is received, the SR may be sent to the base station multiple times, and when a quantity of times of sending the SR exceeds a preset quantity of times and no uplink grant returned by the base station is received, the SR is sent on a carrier or carrier group in the multiple carriers except a carrier or carrier group triggering the SR.

404: After receiving the SR, the base station sends an uplink grant on any carrier or carrier group of the base station to the UE.

In this embodiment of the present invention, description is made by using an example in which the base station sends an uplink grant on any carrier or carrier group of the base station to the user equipment according to the received SR.

405: The UE receives the uplink grant, and adds a BSR to any carrier or carrier group in the multiple carriers or carrier groups of the UE according to the uplink grant and sends the BSR to the base station.

Preferably, the BSR is carried in a PUSCH (physical uplink shared channel) resource of the any carrier or carrier group and sent to the base station.

406: After receiving the BSR, the base station sends an uplink grant on any carrier or carrier group of the base station to the UE according to the BSR.

407: The UE sends uplink data to the base station, and the process ends.

In the method provided in this embodiment of the present invention, when user equipment (UE) has a schedule request (SR) in a pending state, the SR is sent to a base station according to configuration statuses of uplink resources of multiple carriers or carrier groups of the UE, so that after receiving the SR, the base station allocates an uplink grant to the UE, and the UE sends a buffer status report (BSR) by using the uplink grant. By using the technical solution of the present invention, uplink resources are configured on multiple carriers or carrier groups of UE, so that when an SR is triggered, at least one carrier can be selected according to specific configuration statuses of the uplink resources to send the SR; therefore, a problem that a delay in sending the SR is caused due to existing limitations of the uplink resources is avoided, and the SR can be flexibly sent according to the specific configuration statuses of the uplink resources of the carriers or carrier groups.

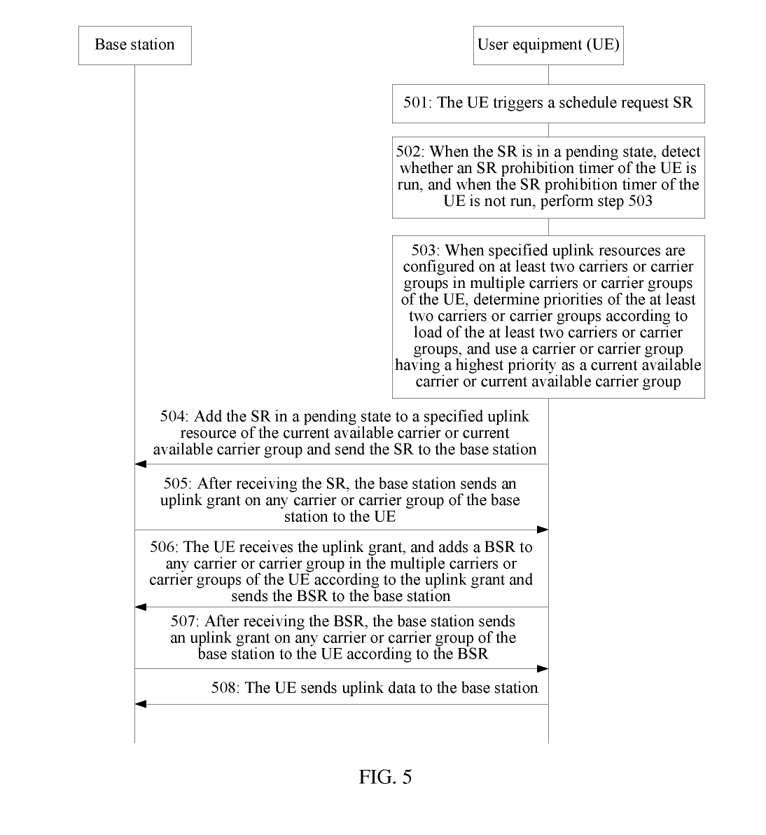

FIG. 5 is a flowchart of a scheduling method according to an embodiment of the present invention. In this embodiment of the present invention, two parties of interaction are user equipment and a base station, and description is made by using an example in which when an SR is in a pending state and specified uplink resources are configured on at least two carriers or carrier groups in multiple carriers or carrier groups, the SR in a pending state is carried, according to priorities of the at least two carriers or carrier groups, in a specified uplink resource of a carrier or carrier group with a highest priority, and sent to the base station, where the priorities of the at least two carriers or carrier groups are determined according to load of the at least two carriers groups. Referring to FIG. 5, the method includes:

501: UE triggers a schedule request (SR).

Optionally, before step 501, the method further includes step 500:

500: A base station configures an SR sending manner by using an RRC message.

The base station configures an SR sending manner, that is a configuration status of a specified uplink resource, for the UE by using an RRC message, and sends the SR sending manner to the UE. When acquiring the RRC message, the UE can learn the configuration status of the specified uplink resource, so as to send an SR according to the specified uplink resource in a subsequent process.

502: When the SR is in a pending state, detect whether an SR prohibition timer of the UE is run, and when the SR prohibition timer of the UE is not run, perform step 503.

503: When specified uplink resources are configured on at least two carriers or carrier groups in multiple carriers or carrier groups of the UE, determine priorities of the at least two carriers or carrier groups according to load of the at least two carriers or carrier groups, and use a carrier or carrier group having a highest priority as a current available carrier or current available carrier group.

504: Add the SR in a pending state to a specified uplink resource of the current available carrier or current available carrier group and send the SR to the base station.

Assuming that a preset initial value is 0, that is, after the SR is triggered, an SR_COUNTER is initialized to 0, when a time in which the SR_COUNTER keeps being 0 exceeds a first preset time length and no uplink grant is received, the SR may be sent on a carrier or carrier group in the multiple carriers except a carrier triggering the SR.

505: After receiving the SR, the base station sends an uplink grant on any carrier or carrier group of the base station to the UE.

In this embodiment of the present invention, description is made by using an example in which the base station sends an uplink grant on any carrier or carrier group of the base station to the user equipment according to the received SR.

506: The UE receives the uplink grant, and adds a BSR to any carrier or carrier group in the multiple carriers or carrier groups of the UE according to the uplink grant and sends the BSR to the base station.

507: After receiving the BSR, the base station sends an uplink grant on any carrier or carrier group of the base station to the UE according to the BSR.

508: The UE sends uplink data to the base station, and the process ends.

In the method provided in this embodiment of the present invention, when user equipment (UE) has a schedule request (SR) in a pending state, the SR is sent to a base station according to configuration statuses of uplink resources of multiple carriers or carrier groups of the UE, so that after receiving the SR, the base station allocates an uplink grant to the UE, and the UE sends a buffer status report (BSR) by using the uplink grant. By using the technical solution of the present invention, uplink resources are configured on multiple carriers or carrier groups of UE, so that when an SR is triggered, at least one carrier can be selected according to specific configuration statuses of the uplink resources to send the SR; therefore, a problem that a delay in sending the SR is caused due to existing limitations of the uplink resources is avoided, and the SR can be flexibly sent according to the specific configuration statuses of the uplink resources of the carriers or carrier groups.

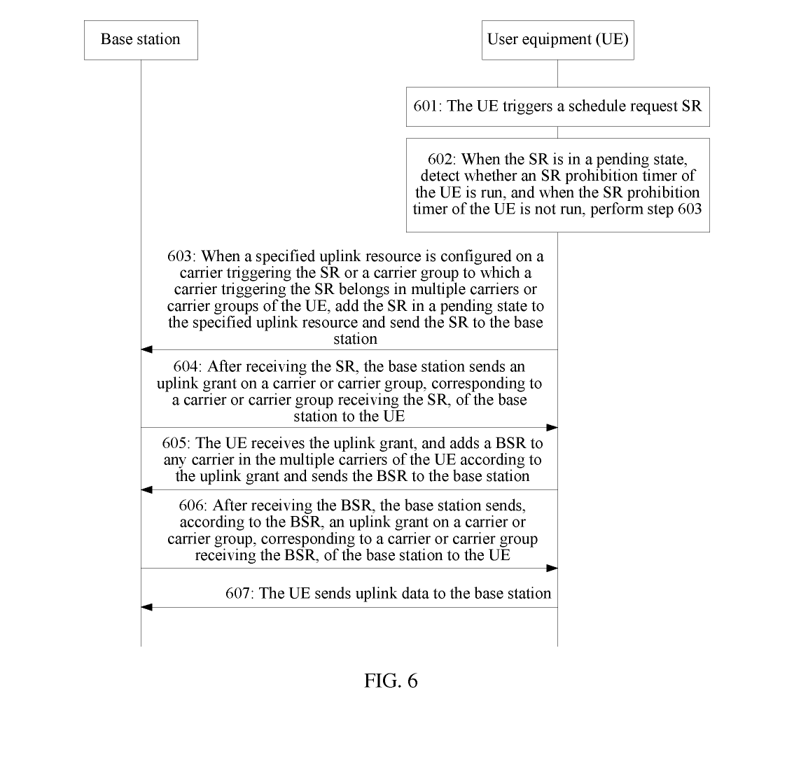

FIG. 6 is a flowchart of a scheduling method according to an embodiment of the present invention. In this embodiment of the present invention, two parties of interaction are user equipment and a base station, and description is made by using an example in which when an SR is in a pending state and a specified uplink resource is configured on a carrier triggering the SR or a carrier group to which a carrier triggering the SR belongs in multiple carriers or carrier groups, the SR in a pending state is carried in the specified uplink resource and sent to the base station.

Referring to FIG. 6, the method includes:

601: UE triggers a schedule request (SR).

Optionally, before step 601, the method further includes step 600:

600: A base station configures an SR sending manner by using a MAC CE message.

The base station configures an SR sending manner, that is a configuration status of a specified uplink resource, for the UE by using a MAC CE message, and sends the SR sending manner to the UE. When acquiring the MAC CE message, the UE can learn the configuration status of the specified uplink resource, so as to send an SR according to the specified uplink resource in a subsequent process.

602: When the SR is in a pending state, detect whether an SR prohibition timer of the UE is run, and when the SR prohibition timer of the UE is not run, perform step 603.

603: When a specified uplink resource is configured on a carrier triggering the SR or a carrier group to which a carrier triggering the SR belongs in multiple carriers or carrier groups of the UE, add the SR in a pending state to the specified uplink resource and send the SR to the base station.

When a current data rate of any radio bearer of the UE is less than a first data rate, the SR is sent on a carrier or carrier group in the multiple carriers or carrier groups except the carrier or carrier group triggering the SR.

604: After receiving the SR, the base station sends an uplink grant on a carrier or carrier group, corresponding to a carrier or carrier group receiving the SR, of the base station to the UE.

In this embodiment of the present invention, description is made by using an example in which the base station sends, according to the received SR, an uplink grant on a carrier or carrier group, corresponding to a carrier or carrier group receiving the SR, of the base station to the user equipment.

605: The UE receives the uplink grant, and adds a BSR to any carrier in the multiple carriers of the UE according to the uplink grant and sends the BSR to the base station.

606: After receiving the BSR, the base station sends, according to the BSR, an uplink grant on a carrier or carrier group, corresponding to a carrier or carrier group receiving the BSR, of the base station to the UE.

In this embodiment of the present invention, description is made by using an example in which the base station sends, according to the received BSR, an uplink grant on a carrier or carrier group, corresponding to a carrier or carrier group receiving the BSR, of the base station to the user equipment.

607: The UE sends uplink data to the base station, and the process ends.

In the method provided in this embodiment of the present invention, when user equipment (UE) has a schedule request (SR) in a pending state, the SR is sent to a base station according to configuration statuses of uplink resources of multiple carriers or carrier groups of the UE, so that after receiving the SR, the base station allocates an uplink grant to the UE, and the UE sends a buffer status report (BSR) by using the uplink grant. By using the technical solution of the present invention, uplink resources are configured on multiple carriers or carrier groups of UE, so that when an SR is triggered, at least one carrier can be selected according to specific configuration statuses of the uplink resources to send the SR; therefore, a problem that a delay in sending the SR is caused due to existing limitations of the uplink resources is avoided, and the SR can be flexibly sent according to the specific configuration statuses of the uplink resources of the carriers or carrier groups.

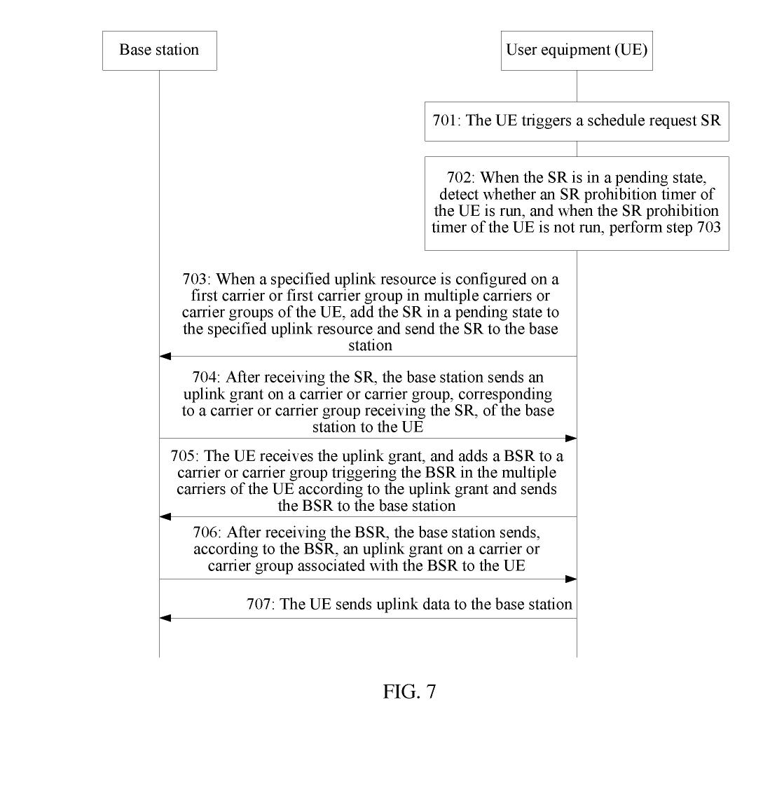

FIG. 7 is a flowchart of a scheduling method according to an embodiment of the present invention. In this embodiment of the present invention, two parties of interaction are user equipment and a base station, and description is made by using an example in which when an SR is in a pending state and a specified uplink resource is configured on a first carrier or first carrier group in multiple carriers or carrier groups, the SR in a pending state is carried in the specified uplink resource and sent to the base station. Referring to FIG. 7, the method includes:

701: UE triggers a schedule request (SR).

Optionally, before step 701, the method further includes step 700:

700: A base station configures an SR sending manner by using a MAC CE message.

The base station configures an SR sending manner, that is a configuration status of a specified uplink resource, for the UE by using a MAC CE message, and sends the SR sending manner to the UE. When acquiring the MAC CE message, the UE can learn the configuration status of the specified uplink resource, so as to send an SR according to the specified uplink resource in a subsequent process.

702: When the SR is in a pending state, detect whether an SR prohibition timer of the UE is run, and when the SR prohibition timer of the UE is not run, perform step 703.

703: When a specified uplink resource is configured on a first carrier or first carrier group in multiple carriers or carrier groups of the UE, add the SR in a pending state to the specified uplink resource and send the SR to the base station.

The first carrier or first carrier group is a carrier or carrier group corresponding to a radio bearer to which an evolved packet system (EPS) bearer, corresponding to a logical channel group that corresponds to a BSR triggering the SR, is mapped.

In this embodiment of the present invention, when a current data rate of the UE is less than a second data rate, the SR is sent on a carrier or carrier group in the multiple carriers or carrier groups except a carrier or carrier group triggering the SR.

704: After receiving the SR, the base station sends an uplink grant on a carrier or carrier group, corresponding to a carrier or carrier group receiving the SR, of the base station to the UE.

In this embodiment of the present invention, description is made by using an example in which the base station sends, according to the received SR, an uplink grant on a carrier or carrier group, corresponding to a carrier or carrier group receiving the SR, of the base station to the user equipment.

705: The UE receives the uplink grant, and adds a BSR to a carrier or carrier group triggering the BSR in the multiple carriers of the UE according to the uplink grant and sends the BSR to the base station.

In this embodiment of the present invention, the SR is triggered on the basis that the BSR is triggered, that is, when the UE needs to send uplink data to the base station, the BSR is triggered, and the BSR triggers the SR. Preferably, when data rates provided by the carriers or carrier groups to the UE are less than data rates that should be provided by the carriers or carrier groups to the UE according to network configuration, it may be considered that a carrier or carrier group with a highest priority in the carriers or carrier groups is the carrier or carrier group triggering the BSR.

706: After receiving the BSR, the base station sends, according to the BSR, an uplink grant on a carrier or carrier group associated with the BSR to the UE.

In this embodiment of the present invention, description is made by using an example in which the base station sends, according to the received BSR, an uplink grant on a carrier or carrier group associated with the BSR to the user equipment.

707: The UE sends uplink data to the base station, and the process ends.

In the method provided in this embodiment of the present invention, when user equipment (UE) has a schedule request (SR) in a pending state, the SR is sent to a base station according to configuration statuses of uplink resources of multiple carriers or carrier groups of the UE, so that after receiving the SR, the base station allocates an uplink grant to the UE, and the UE sends a buffer status report (BSR) by using the uplink grant. By using the technical solution of the present invention, uplink resources are configured on multiple carriers or carrier groups of UE, so that when an SR is triggered, at least one carrier can be selected according to specific configuration statuses of the uplink resources to send the SR; therefore, a problem that a delay in sending the SR is caused due to existing limitations of the uplink resources is avoided, and the SR can be flexibly sent according to the specific configuration statuses of the uplink resources of the carriers or carrier groups.

The embodiments of the present invention further give embodiments of apparatuses that implement the steps and methods in the foregoing method embodiments. The embodiments of the present invention may be applied to UE in various communications systems.

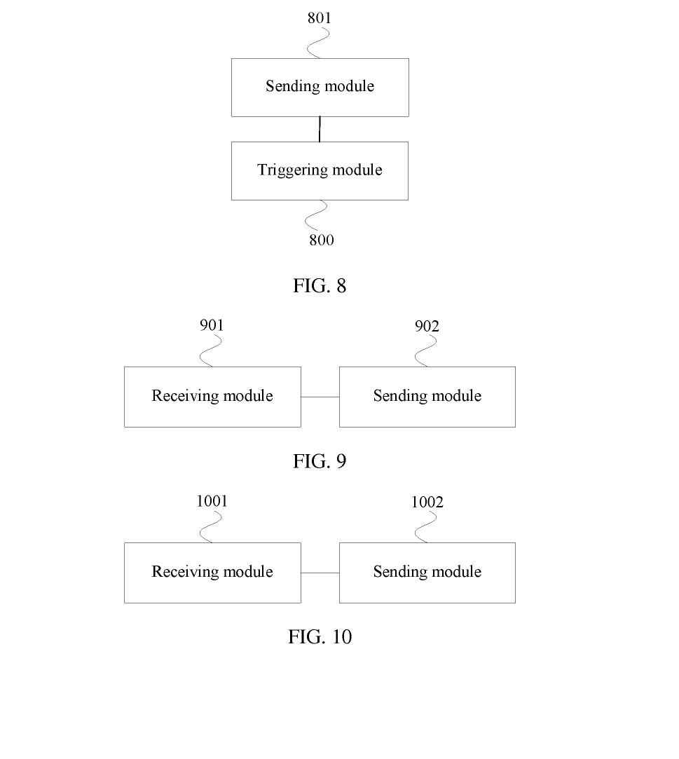

FIG. 8 is a schematic structural diagram of user equipment (UE) according to an embodiment of the present invention. Referring to FIG. 8, the user equipment (UE) includes: a triggering module 800 and a sending module 801, where

the triggering module 800 is configured to trigger a schedule request (SR); the triggering module 800 is connected to the sending module 801; and the sending module 801 is configured to send the SR to a base station according to configuration statuses of uplink resources of multiple carriers or carrier groups of the UE.

Optionally, the sending module 801 includes: a first SR sending unit, configured to: when a specified uplink resource is configured on any carrier or carrier group in the multiple carriers or carrier groups, add the SR to the specified uplink resource and send the SR to the base station, where the specified uplink resource is an uplink resource used for sending the SR; or a second SR sending unit, configured to: when specified uplink resources are configured on at least two carriers or carrier groups in the multiple carriers or carrier groups, add, according to priorities of the at least two carriers or carrier groups, the SR to a specified uplink resource of a carrier or carrier group with a highest priority, and send the SR to the base station; or a third SR sending unit, configured to: when a specified uplink resource is configured on a carrier triggering the SR or a carrier group to which a carrier triggering the SR belongs in the multiple carriers or carrier groups, add the SR to the specified uplink resource and send the SR to the base station; or a fourth SR sending unit, configured to: when a specified uplink resource is configured on a first carrier or carrier group in the multiple carriers or carrier groups, add the SR to the specified uplink resource and send the SR to the base station, where the first carrier or carrier group is a carrier or carrier group corresponding to a radio bearer to which an evolved packet system (EPS) bearer, corresponding to a logical channel group that corresponds to a BSR triggering the SR, is mapped.

Optionally, the priorities of the at least two carriers or carrier groups are determined according to priorities, which are configured by the base station, of the carriers or carrier groups; or the priorities of the at least two carriers or carrier groups are determined according to load of the at least two carriers or carrier groups; or the priorities of the at least two carriers or carrier groups are determined according to ratios of data rates provided by the at least two carriers or carrier groups to the UE to an ideal data rate of each carrier in each carrier or carrier group in the at least two carriers or carrier groups.

Optionally, the user equipment further includes: an uplink grant receiving module, configured to receive an uplink grant that is sent by the base station according to the SR; and the sending module 801 further includes:

a first BSR sending unit, configured to add a buffer status report (BSR) to any carrier or carrier group in the multiple carriers or carrier groups of the UE according to the uplink grant and send the BSR to the base station; or a second BSR sending unit, configured to add a buffer status report (BSR) to a carrier or carrier group triggering the BSR in the multiple carriers or carrier groups of the UE according to the uplink grant, and send the BSR to the base station; or a third BSR sending unit, configured to add a buffer status report (BSR) to a first carrier or first carrier group in the multiple carriers or carrier groups of the UE according to the uplink grant and send the BSR to the base station, where the first carrier or first carrier group is the carrier or carrier group corresponding to the radio bearer to which the evolved packet system (EPS) bearer, corresponding to the logical channel group that corresponds to the BSR triggering the SR, is mapped.

Optionally, the sending module further includes: a preset-quantity of times sending unit, configured to: when a quantity of times of sending the SR exceeds a preset quantity of times and no uplink grant returned by the base station is received, send the SR on a carrier or carrier group in the multiple carriers or carrier groups except the carrier or carrier group triggering the SR; or a preset-time-length sending unit, configured to: when no uplink grant is received within a first preset time length after the SR is triggered, send the SR on a carrier or carrier group in the multiple carriers or carrier groups except the carrier or carrier group triggering the SR; or a first-rate sending unit, configured to: when a current data rate of any radio bearer of the UE is less than a first data rate, send the SR on a carrier or carrier group in the multiple carriers or carrier groups except the carrier or carrier group triggering the SR; or a first-rate and time-length sending unit, configured to: when a current data rate of any radio bearer of the UE is less than a first data rate and keeps in a state of being less than the first data rate for a time longer than a second preset time length, send the SR on a carrier or carrier group in the multiple carriers or carrier groups except the carrier or carrier group triggering the SR; or a second-rate sending unit, configured to: when a current data rate of the UE is less than a second data rate, send the SR on a carrier or carrier group in the multiple carriers or carrier groups except the carrier or carrier group triggering the SR; or a second-rate and time-length sending unit, configured to: when a current data rate of the UE is less than a second data rate and keeps in a state of being less than the second data rate for a time longer than a third preset time length, send the SR on a carrier or carrier group in the multiple carriers or carrier groups except the carrier or carrier group triggering the SR.

Optionally, the sending module 801 further includes: a first prohibition timer unit, configured to: when an SR prohibition timer of the UE is not run, send the SR to the base station according to the configuration statuses of the uplink resources of the multiple carriers or carrier groups of the UE; or a second prohibition timer unit, configured to: when an SR prohibition timer of the carrier or carrier group triggering the SR is not run, send the SR to the base station according to the configuration statuses of the uplink resources of the multiple carriers or carrier groups of the UE.

Optionally, the UE further includes: a receiving module, configured to acquire, by the UE, an SR sending manner configured by using a Radio Resource Control (RRC) message or a Media Access Control control element (MAC CE).

The sending module may be a transmitter or a transceiver, the uplink grant receiving module may be a receiver or a transceiver, and the sending module and the uplink grant receiving module may be integrated to construct a transceiver unit, which, corresponding to hardware, is implemented as a transceiver. The other modules above may be embedded in or independent of a processor of the UE in a form of hardware, or may be stored in a memory of the UE in a form of software, so as to be invoked by the processor to execute operations corresponding to the foregoing modules. The processor may be a central processing unit (CPU), a micro processor, a single chip microcomputer, or the like.

FIG. 9 is a schematic structural diagram of a base station according to an embodiment of the present invention. Referring to FIG. 9, the base station includes:

a receiving module 901, configured to receive an SR sent by user equipment; and

a sending module 902, configured to send an uplink grant on any carrier or carrier group of the base station to the user equipment according to the received SR; or configured to send, according to the received SR, an uplink grant on a carrier or carrier group, corresponding to a carrier or carrier group receiving the SR, of the base station to the user equipment.

The sending module 902 may be a transmitter or a transceiver, the receiving module 901 may be a receiver or a transceiver, and the sending module 902 and the receiving module 901 may be integrated to construct a transceiver unit, which, corresponding to hardware, is implemented as a transceiver.

FIG. 10 is a schematic structural diagram of a base station according to an embodiment of the present invention. Referring to FIG. 10, the base station includes:

a receiving module 1001, configured to receive a BSR sent by user equipment; and

a sending module 1002, configured to send an uplink grant on any carrier or carrier group to the user equipment according to the received BSR; or configured to send, according to the received BSR, an uplink grant on a carrier or carrier group corresponding to a carrier or carrier group receiving the BSR to the user equipment; or configured to send, according to the received BSR, an uplink grant on a carrier or carrier group associated with the BSR to the user equipment.

The sending module 1002 may be a transmitter or a transceiver, the receiving module 1001 may be a receiver or a transceiver, and the sending module 1002 and the receiving module 1001 may be integrated to construct a transceiver unit, which, corresponding to hardware, is implemented as a transceiver.

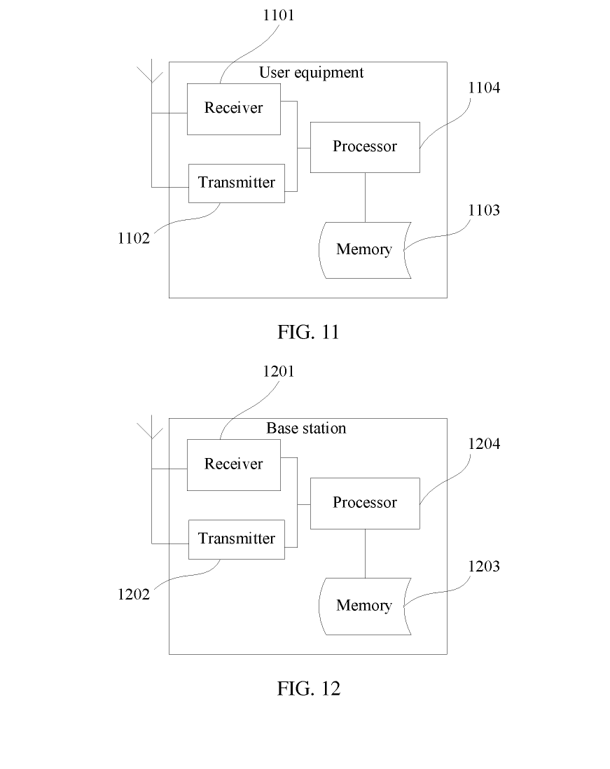

FIG. 11 is a schematic structural diagram of user equipment according to an embodiment of the present invention. Referring to FIG. 11, the user equipment includes: a receiver 1101, a transmitter 1102, a memory 1103, and a processor 1104, where the receiver 1101 and the transmitter 1102 are separately connected to the processor 1104, the memory 1103 stores program code, and the processor 1104 is configured to invoke the program code, to execute the following operations: triggering a schedule request (SR); and sending the SR to a base station according to configuration statuses of uplink resources of multiple carriers or carrier groups through the transmitter 1102.

Optionally, the processor 1104 is further configured to invoke the program code, to execute the following operations: when a specified uplink resource is configured on any carrier or carrier group in the multiple carriers or carrier groups, adding the SR to the specified uplink resource and sending the SR to the base station, where the specified uplink resource is an uplink resource used for sending the SR; or

when specified uplink resources are configured on at least two carriers or carrier groups in the multiple carriers or carrier groups, adding, according to priorities of the at least two carriers or carrier groups, the SR to a specified uplink resource of a carrier or carrier group with a highest priority, and sending the SR to the base station; or

when a specified uplink resource is configured on a carrier triggering the SR or a carrier group to which a carrier triggering the SR belongs in the multiple carriers or carrier groups, adding the SR to the specified uplink resource and sending the SR to the base station; or

when a specified uplink resource is configured on a first carrier or carrier group in the multiple carriers or carrier groups, adding the SR to the specified uplink resource and sending the SR to the base station, where the first carrier or carrier group is a carrier or carrier group corresponding to a radio bearer to which an evolved packet system (EPS) bearer, corresponding to a logical channel group that corresponds to a BSR triggering the SR, is mapped.

Optionally, the processor 1104 is further configured to invoke the program code, to execute the following operation: the priorities of the at least two carriers or carrier groups are determined according to priorities, which are configured by the base station, of the carriers or carrier groups; or

the priorities of the at least two carriers or carrier groups are determined according to load of the at least two carriers or carrier groups; or

the priorities of the at least two carriers or carrier groups are determined according to ratios of data rates provided by the at least two carriers or carrier groups to the UE to an ideal data rate of each carrier in each carrier or carrier group in the at least two carriers or carrier groups.

Optionally, the processor 1104 is further configured to invoke the program code, to execute the following operations: receiving an uplink grant that is sent by the base station according to the SR; and

adding a buffer status report (BSR) to any carrier or carrier group in the multiple carriers or carrier groups of the UE according to the uplink grant and sending the BSR to the base station; or

adding a buffer status report (BSR) to a carrier or carrier group triggering the BSR in the multiple carriers or carrier groups of the UE according to the uplink grant, and sending the BSR to the base station; or

adding a buffer status report (BSR) to a first carrier or first carrier group in the multiple carriers or carrier groups of the UE according to the uplink grant and sending the BSR to the base station, where the first carrier or first carrier group is the carrier or carrier group corresponding to the radio bearer to which the evolved packet system (EPS) bearer, corresponding to the logical channel group that corresponds to the BSR triggering the SR, is mapped.

Optionally, the processor 1104 is further configured to invoke the program code, to execute the following operation: when a quantity of times of sending the SR exceeds a preset quantity of times and no uplink grant returned by the base station is received, sending the SR on a carrier or carrier group in the multiple carriers or carrier groups except the carrier or carrier group triggering the SR; or

when no uplink grant is received within a first preset time length after the SR is triggered, sending the SR on a carrier or carrier group in the multiple carriers or carrier groups except the carrier or carrier group triggering the SR; or

when a current data rate of any radio bearer of the UE is less than a first data rate, sending the SR on a carrier or carrier group in the multiple carriers or carrier groups except the carrier or carrier group triggering the SR; or

when a current data rate of any radio bearer of the UE is less than a first data rate and keeps in a state of being less than the first data rate for a time longer than a second preset time length, sending the SR on a carrier or carrier group in the multiple carriers or carrier groups except the carrier or carrier group triggering the SR; or

when a current data rate of the UE is less than a second data rate, sending the SR on a carrier or carrier group in the multiple carriers or carrier groups except the carrier or carrier group triggering the SR; or

when a current data rate of the UE is less than a second data rate and keeps in a state of being less than the second data rate for a time longer than a third preset time length, sending the SR on a carrier or carrier group in the multiple carriers or carrier groups except the carrier or carrier group triggering the SR.

Optionally, the processor 1104 is further configured to invoke the program code, to execute the following operation: when an SR prohibition timer of the UE is not run, sending the SR to the base station according to the configuration statuses of the uplink resources of the multiple carriers or carrier groups of the UE;

or

when an SR prohibition timer of the carrier or carrier group triggering the SR is not run, sending the SR to the base station according to the configuration statuses of the uplink resources of the multiple carriers or carrier groups of the UE.

Optionally, the processor 1104 is further configured to invoke the program code, to execute the following operation: acquiring, by the UE, an SR sending manner configured by using a Radio Resource Control (RRC) message or a Media Access Control control element (MAC CE).

It should be noted that, the user equipment shown in FIG. 11 can be configured to implement any method provided in the foregoing method embodiments; and descriptions of triggering of the SR and a configuration status of a specified uplink resource are the same as those in the foregoing method embodiments, and details are not repeated herein.

FIG. 12 is a schematic structural diagram of a base station according to an embodiment of the present invention. Referring to FIG. 12, the base station includes: a receiver 1201, a transmitter 1202, a memory 1203, and a processor 1204, where the receiver 1201 and the transmitter 1202 are separately connected to the processor 1204. Certainly, the base station may further include universal components such as an antenna, a baseband processing component, an intermediate radio frequency processing component, and an input and output apparatus, which is not limited in any form in this embodiment of the present invention.

The memory 1203 stores program code, and the processor 1204 is configured to invoke the program code, to execute the following operations:

receiving, through the receiver 1201, an SR sent by user equipment; and

sending, according to the received SR and through the transmitter 1202, an uplink grant on any carrier or carrier group of the base station to the user equipment; or

sending, according to the received SR and through the transmitter 1202, an uplink grant on a carrier or carrier group, corresponding to a carrier or carrier group receiving the SR, of the base station to the user equipment.

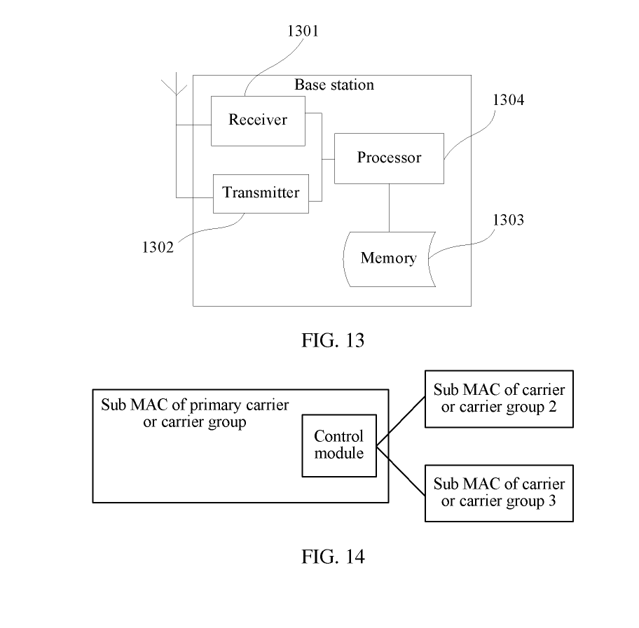

FIG. 13 is a schematic structural diagram of a base station according to an embodiment of the present invention. Referring to FIG. 13, the base station includes: a receiver 1301, a transmitter 1302, a memory 1303, and a processor 1304, where the receiver 1301 and the transmitter 1302 are separately connected to the processor 1304. Certainly, the base station may further include universal components such as an antenna, a baseband processing component, an intermediate radio frequency processing component, and an input and output apparatus, which is not limited in any form in this embodiment of the present invention.

The memory 1303 stores program code, and the processor 1304 is configured to invoke the program code, to execute the following operations:

receiving, through the receiver 1301, a BSR sent by user equipment; and

sending, according to the received BSR and through the transmitter 1302, an uplink grant on any carrier or carrier group of the base station to the user equipment; or

sending, according to the received BSR and through the transmitter 1302, an uplink grant on a carrier or carrier group, corresponding to a carrier or carrier group receiving the BSR, of the base station to the user equipment; or

sending, according to the received BSR and through the transmitter 1302, an uplink grant on a carrier or carrier group associated with the BSR to the user equipment.

It should be noted that, the base stations shown in FIG. 12 and FIG. 13 can be configured to implement any method provided in the foregoing method embodiments; and descriptions of triggering of the SR and a configuration status of a specified uplink resource are the same as those in the foregoing method embodiments, and details are not repeated herein.

A person of ordinary skill in the art may understand that all or some of the steps of the embodiments may be implemented by hardware or a program instructing related hardware. The program may be stored in a computer-readable storage medium. The storage medium may include: a read-only memory, a magnetic disk, or an optical disc.

FIG. 14 is a schematic structural diagram of a MAC of user equipment according to an embodiment of the present invention. Referring to FIG. 14, a sub MAC (MAC sublayer) of a primary carrier or carrier group has a control module, a sub MAC of a secondary carrier or carrier group does not have a control module, and all control is performed by the control module of the primary carrier or carrier group. The control module is a part of a processor, and configured to control sending of an SR.

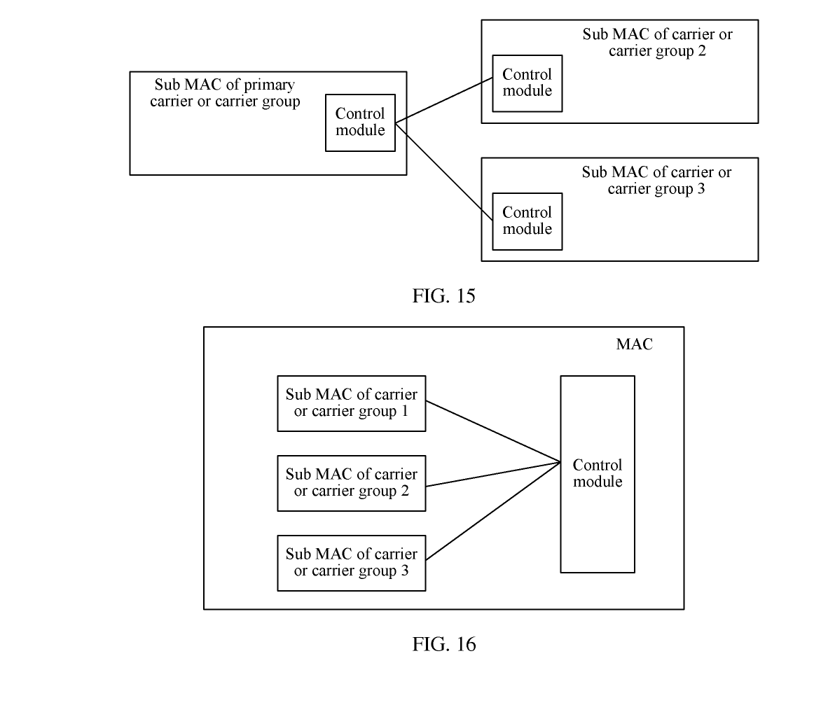

FIG. 15 is a schematic structural diagram of another MAC of user equipment according to an embodiment of the present invention. Referring to FIG. 15, a sub MAC of each carrier or carrier group has a control module, and a control module of each secondary carrier or carrier group is logically connected to a control module of a primary carrier or carrier group. The control module is a part of a processor, and configured to control sending of an SR.

FIG. 16 is a schematic structural diagram of another MAC of user equipment according to an embodiment of the present invention. Referring to FIG. 16, a sub-MAC of each carriers or carrier groups does not have a control module, and the control module is independent in the MAC. The control module is a part of a processor, and configured to control sending of an SR.

The foregoing descriptions are merely exemplary embodiments of the present invention, but are not intended to limit the present invention. Any modification, equivalent replacement, and improvement made without departing from the spirit and principle of the present invention shall fall within the protection scope of the present invention.

What is claimed is:

1. A scheduling method, wherein the method comprises:
triggering, by user equipment (UE), a schedule request (SR); and
sending, by the UE, the SR to a base station according to configuration statuses of uplink resources of multiple carriers or carrier groups of the UE.

2. The method according to claim 1, wherein the sending the SR to the base station comprises:
sending, when a specified uplink resource is configured on any carrier or carrier group in the multiple carriers or carrier groups, the SR on the specified uplink resource to the base station, wherein the specified uplink resource is an uplink resource used for sending the SR.

3. The method according to claim 1, wherein the sending the SR to the base station comprises:
sending, when specified uplink resources are configured on at least two carriers or carrier groups in the multiple carriers or carrier groups, according to priorities of the at least two carriers or carrier groups, the SR on a specified uplink resource of a carrier or carrier group with a highest priority, to the base station.

4. The method according to claim 3, wherein
the priorities of the at least two carriers or carrier groups are determined according to priorities, which are configured by the base station, of the carriers or carrier groups; or
the priorities of the at least two carriers or carrier groups are determined according to load of the at least two carriers or carrier groups; or
the priorities of the at least two carriers or carrier groups are determined according to ratios of data rates provided by the at least two carriers or carrier groups to the UE to an ideal data rate of each carrier in the at least two carriers or carrier groups.

5. The method according to claim 1, wherein the sending the SR to the base station comprises:
sending, when a specified uplink resource is configured on a carrier triggering the SR or a carrier group to which a carrier triggering the SR belongs in the multiple carriers or carrier groups, the SR on the specified uplink resource to the base station.

6. The method according to claim 1, wherein the sending the SR to the base station comprises:
sending, when a specified uplink resource is configured on a first carrier or carrier group in the multiple carriers or carrier groups, the SR on the specified uplink resource to the base station, wherein the first carrier or carrier group is a carrier or carrier group corresponding to a radio bearer to which an evolved packet system (EPS) bearer, corresponding to a logical channel group that corresponds to a buffer status report (BSR) triggering the SR, is mapped.

7. The method according to claim 1, wherein after the sending the SR to the base station, the method further comprises:
receiving an uplink grant that is sent by the base station according to the SR; and
sending, according to the uplink grant, a buffer status report (BSR) to a carrier or carrier group in the multiple carriers or carrier groups of the UE to the base station.

8. The method according to claim 1, wherein after the sending the SR to the base station, the method further comprises:
when any of the following situations is fulfilled, sending the SR on a carrier or carrier group in the multiple carriers or carrier groups except the carrier or carrier group triggering the SR:
a quantity of times of sending the SR exceeds a preset quantity of times and no uplink grant returned by the base station is received;
no uplink grant is received within a first preset time length after the SR is triggered;
a current data rate of any radio bearer of the UE is less than a first data rate;
a current data rate of any radio bearer of the UE is less than a first data rate and keeps in a state of being less than the first data rate for a time longer than a second preset time length;
a current data rate of the UE is less than a second data rate; and
a current data rate of the UE is less than a second data rate and keeps in a state of being less than the second data rate for a time longer than a third preset time length.

9. The method according to claim 1, wherein the sending the SR to the base station comprises:
sending, when an SR prohibition timer of the UE is not run, the SR to the base station according to the configuration statuses of the uplink resources of the multiple carriers or carrier groups of the UE.

10. The method according to claim 9, wherein the SR prohibition timer of the UE is an SR prohibition timer of the carrier or carrier group triggering the SR.

11. The method according to claim 1, wherein before the sending the SR to the base station, the method further comprises:
acquiring, by the UE, an SR sending manner configured by using a Radio Resource Control (RRC) message or a Media Access Control control element (MAC CE).

12. A scheduling method, comprising:
configuring, by a base station and before receiving a schedule request (SR), an uplink resource on a multiple carrier or carrier group for user equipment (UE), wherein the uplink resource is used for sending the SR;
receiving, by the base station, the SR sent by the UE; and
sending, by the base station according to the received SR, an uplink grant to the user equipment.

13. User equipment, comprising: a receiver, a transmitter, a memory, and a processor, wherein the receiver, the transmitter, and the memory are separately connected to the processor, the memory stores program code, and the processor is configured to invoke the program code, to execute the following operations:
triggering a schedule request (SR); and
sending, through the transmitter, the SR to a base station according to configuration statuses of uplink resources of multiple carriers or carrier groups of the user equipment.

14. The user equipment according to claim 13, wherein the program code executed for sending the SR to the base station comprises program code for:
sending, when a specified uplink resource is configured on any carrier or carrier group in the multiple carriers or carrier groups, the SR on the specified uplink resource to the base station, wherein the specified uplink resource is an uplink resource used for sending the SR.

15. The user equipment according to claim 13, wherein the program code executed for sending the SR to the base station comprises program code for:
sending, when specified uplink resources are configured on at least two carriers or carrier groups in the multiple carriers or carrier groups, according to priorities of the at least two carriers or carrier groups, the SR on a specified uplink resource of a carrier or carrier group with a highest priority, to the base station.

16. The user equipment according to claim 15, wherein
the priorities of the at least two carriers or carrier groups are determined according to priorities, which are configured by the base station, of the carriers or carrier groups; or
the priorities of the at least two carriers or carrier groups are determined according to load of the at least two carriers or carrier groups; or
the priorities of the at least two carriers or carrier groups are determined according to ratios of data rates provided by the at least two carriers or carrier groups to the UE to an ideal data rate of each carrier in the at least two carriers or carrier groups.

17. The user equipment according to claim 13, wherein the program code executed for sending the SR to the base station comprises program code for:
sending, when a specified uplink resource is configured on a carrier triggering the SR or a carrier group to which a carrier triggering the SR belongs in the multiple carriers or carrier groups, the SR on the specified uplink resource to the base station.

18. The user equipment according to claim 13, wherein the program code executed for sending the SR to the base station comprises program code for:
sending, when a specified uplink resource is configured on a first carrier or carrier group in the multiple carriers or carrier groups, the SR on the specified uplink resource to the base station, wherein the first carrier or carrier group is a carrier or carrier group corresponding to a radio bearer to which an evolved packet system (EPS) bearer, corresponding to a logical channel group that corresponds to a buffer status report (BSR) triggering the SR, is mapped.

19. The user equipment according to claim 13, wherein the program code further comprises program code for:
receiving an uplink grant that is sent by the base station according to the SR; and
sending, according to the uplink grant, a buffer status report (BSR) to a carrier or carrier group in the multiple carriers or carrier groups of the UE to the base station.

20. The user equipment according to claim 13, wherein the program code further comprises program code for:
when any of the following situations is fulfilled, sending the SR on a carrier or carrier group in the multiple carriers or carrier groups except the carrier or carrier group triggering the SR:
a quantity of times of sending the SR exceeds a preset quantity of times and no uplink grant returned by the base station is received;
no uplink grant is received within a first preset time length after the SR is triggered;
a current data rate of any radio bearer of the UE is less than a first data rate;
a current data rate of any radio bearer of the UE is less than a first data rate and keeps in a state of being less than the first data rate for a time longer than a second preset time length;
a current data rate of the UE is less than a second data rate; and
a current data rate of the UE is less than a second data rate and keeps in a state of being less than the second data rate for a time longer than a third preset time length.

21. The user equipment according to claim 13, wherein the program code executed for sending the SR to the base station comprises program code for:
sending, when an SR prohibition timer of the UE is not run, the SR to the base station according to the configuration statuses of the uplink resources of the multiple carriers or carrier groups of the UE.

22. The method according to claim 21, wherein the SR prohibition timer of the UE is an SR prohibition timer of the carrier or carrier group triggering the SR.

23. The user equipment according to claim 13, wherein the program code further comprises program code for:
acquiring, by the UE, an SR sending manner configured by using a Radio Resource Control (RRC) message or a Media Access Control control element (MAC CE).

24. A base station, comprising: a receiver, a transmitter, a memory, and a processor, wherein the receiver, the transmitter, and the memory are separately connected to the processor, the memory stores program code, and the processor is configured to invoke the program code, to execute the following operations:
configuring, before receiving a schedule request (SR), an uplink resource on a multiple carrier or carrier group for user equipment (UE), wherein the uplink resource is used for sending the SR;
receiving the SR sent by the UE; and
sending, according to the received SR, an uplink grant to the user equipment.
